(19) United States
(12) Patent Application Publication
(10) Pub. No.: US 2018/0347999 A1
(43) Pub. Date: Dec. 6, 2018

(54) METHODS AND SYSTEMS FOR GENERATING REALISTIC TRIPS FOR URBAN MOBILITY SIMULATION

(71) Applicant: Xerox Corporation, Norwalk, CT (US)

(72) Inventor: Boris Chidlovskii, Meylan (FR)

(73) Assignee: Xerox Corporation

(21) Appl. No.: 15/607,882

(22) Filed: May 30, 2017

(51) Int. Cl. G01C 21/34; G06Q 10/04; G08G 1/01; G06F 17/50

(52) U.S. Cl. CPC G01C 21/3492; G06F 17/5009; G08G 1/0112; G06Q 10/047

(57) ABSTRACT

Method and apparatus for generating realistic samples of public transportation usage to improve the operability of a public transportation system. Constraints can be expressed as a group of origin-destination-time triples. A trip (or trips) can then be assigned to each triple among the group of origin-destination-time triples while ignoring capacity constraints. A Metropolis-Hasting class sampling technique can then be applied with respect to the trip beginning with the origin-destination-time triples to generate a realistic sample of public transportation usage based on the aforementioned constraints in the form of target probability distributions and/or target probability densities, thereby improving the public transportation system by taking into account the generated realistic sample of public transportation usage.

### TECHNICAL FIELD

Embodiments are generally related to public transportation systems. Embodiments also relate to urban mobility simulations utilized in the modeling of public transportation systems, urban development, and location choices. Embodiments additionally relate to systems and devices for generating realistic passenger trips in the context of a public transportation system.

### BACKGROUND

Urban mobility simulations play an important role in the modeling the urban development and location choices. One of its important components is the collection of individual passenger trips to be simulated. Given a demand of traveling from origin O to destination D at time T, a trip represents an actual realization of this “ODT” triple. This realization depends on a number of factors, including available services, schedules, their reliability, user priorities and choices. We distinguish between two approaches to generate the trips. The first one deploys urban trip planners (a common service available for many cities around the world). A planner uses available network and schedule information to make recommendations upon a user ODT request, using the optimal trip strategy. The trip planner recommendations can be directly used for the simulation. Unfortunately, they represent an over-optimistic view of user traveling and poorly reflect the real passenger choices.

Another source is an available history of trips, for example, extracted from the e-card validation data. The realized trips reflect the choices users made and multiple factors, which the trip planner may ignore, such as multi-goal trips or the transfer delays. In result, when trips recommended by the trip planner are compared to ones sampled from the trip history, we observe an important mismatch in their characteristics (length, services, transit time, modality choices, etc.). When available, sampling from a trip history is a better strategy for the realistic trip generation. However, the history of trips is limited to the time and space where they were collected. It cannot be reused beyond this context, for example, when the network is changed or we want to simulate a new scenario.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved methods, systems, and devices for generating trips for an urban mobility simulation.

It is another aspect of the disclosed embodiments to provide for improving the operations and efficiencies of a public transportation system.

It is yet another aspect of the disclosed embodiments to provide methods, systems, and devices for generating a large urban trip collection which look realistic (e.g., how usually travel in an urban zone) and can be served as an input to simulate different urban mobility scenarios.

The aforementioned aspects and other objectives and advantages can now be achieved as described herein. A method, system, and apparatus are disclosed for generating realistic samples of public transportation usage to improve the operability of a public transportation system. Constraints can be expressed as a group of origin-destination-time triples. A trip (or trips) can then be assigned to each triple among the group of origin-destination-time triples, while ignoring capacity constraints. A Metropolis-Hasting class sampling technique can then be applied with respect to the trip beginning with the origin-destination-time triples to generate a realistic sample of public transportation usage based on the aforementioned constraints in the form of target probability distributions and/or target probability densities, thereby improving the public transportation system by taking into account the generated realistic sample of public transportation usage.

In the context of urban mobility simulation, the disclosed embodiments address the problem of generating a collection of realistically looking passenger trips. Equivalent to satisfying a set of constraints in a probabilistic form, the target trip collection is expected to be built in such a way that its main characteristics, such as the full trip time, transfer time, walking time, etc., satisfy these constraints. Passenger trips can be generated in two different ways. First, there are urban trip planners designed to recommend trips upon user requests, which are given in the form of an origin-destination-time (ODT) triple. These trip recommendations are to be directly used for the simulation, but they are often over-optimistic and do not reflect real passenger choices. On the other hand, if a history of trips is available for some period of time, this history can be used for sampling trips but can be used for OD's not observed previously. The disclosed embodiments combine the advantages of these two methods for trip generation. An MCMC Metropolis-Hastings algorithm can be employed to start from a trip candidate set and rebuild it in a manner that fits the given constraints.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a graph depicting sample data from a trip dataset including the number of extracted trips by day, in accordance with an example embodiment;

FIG. 2 illustrates three graphs depicting sample trip generation data including trip angle target distribution data specifically target, initial, and final data, in accordance with an example embodiment;

FIGS. 3A-3B illustrate graphs depicting trip generation data with MCMC including transfer and full travel distribution data, in accordance with an example embodiment;

FIG. 4 illustrates a graph depicting data indicative of Metropolis-Hastings algorithm coverage, in accordance with an example embodiment;

FIG. 5 illustrates a flow chart of operations depicting logical operational steps of a method for generating realistic trips, in accordance with an example embodiment;

FIG. 6 illustrates a schematic view of a computer system/apparatus, accordance with an embodiment; and

FIG. 7 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or, characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation.”

In the context of urban mobility simulation, the disclosed embodiments address the problem of generating a collection of realistically looking passenger trips. Equivalent to satisfying a set of constraints in a probabilistic form, the target trip collection can be configured in such a manner that its main characteristics, such as the full trip time, transfer time, walking time, etc., satisfy these constraints. Passenger trips can be generated in two different ways. First, there are urban trip planners designed to recommend trips upon user requests, in the form an origin-destination-time (ODT) triple.

These trip recommendations can be directly used for the simulation, but they are often over-optimistic and do not reflect real passenger choices. On the other hand, if a history of trips is available for some period of time, this history can be used for sampling trips and can also be used for OD's not observed previously. The disclosed embodiments thus combine the advantages of these two methods for trip generation. In addition in some example embodiments, the MCMC Metropolis-Hastings algorithm can be utilized to start from a trip candidate set and rebuild it in a manner that fits the given constraints. Additionally, as will be discussed in greater detail herein, tests for the city of Nancy, France demonstrate the results of convergence for the case of known marginal distributions.

Two approaches can be considered as complementary for trip generation, based on trip planners and history sampling. The disclosed embodiments involve methods, systems, and devices aimed at combining the advantages of these two approaches. In addition, the disclosed embodiments include a method and system that is able to generate realistically looking trips, using either a trip history or trip planner recommendations as a source of trip realizations.

The following four basic steps can generate such realistically looking trips. First, a set of constraints can be set or established that the generated trip collection should satisfy to look realistic. Second, these constraints can be expressed in the form of target probability distributions/densities. Third, all trips in the collection can be initialized by querying a trip planner or by sampling from the trip history. Fourth, a Monte Carlo Markov Chain algorithm can be applied to obtain the trips modified and produce the realistic “look” and to match the collection characteristics to the target distribution. Note that examples of constraints, which can be used to setup the target trip distribution include, for example, the total trip time or/and the transit time; trip angles used for the detecting the multi-goal trips; the number of changes; and trip modalities, modality sequences, etc.

Any of mentioned constraints may be global (for a city) or local (for an urban zone or a given bus service, etc.). The realistic trip generation is critical in the real world and What-If scenarios. Consider the following example. Assume the collection of real trips is available for a current transportation network and a scenario of a network change should be simulated. The trip planner can be first used to make recommendations for the new network part. As these recommendations are artificial and over-optimistic, we may want to modify them to look like the trips in the observed network and available in the history.

Table 1 below summarizes two state of the art approaches versus the focus of the disclosed embodiments.

TABLE 1
Comparative Features of Three Approaches to Trip Generation

| | Trip Planner | Trip History | Disclosed Embodiments |
|---|---|---|---|
| Observed ODTs | Yes | Yes | Yes |
| Unobserved | Yes | No | Yes |
| ODTs | | | |
| Schedules | Yes | Partially | Yes |
| User Choices | No | Yes | Yes |
| Realistic | No | Yes | Yes |

In statistics, Markov chain Monte Carlo (MCMC) methods are a class of algorithms for sampling from a probability distribution based on constructing a Markov chain that has the desired distribution as its equilibrium distribution. The state of the chain after a number of steps is then used as a sample of the desired distribution. The quality of the sample improves as a function of the number of steps. Metropolis-Hastings algorithm generates a random walk using a proposal density and a method for rejecting some of the proposed moves.

Given the target probability density π, defined on a state space x, and computable up to a multiplying constant, the Metropolis-Hastings algorithm proposes a generic technique for constructing a Markov chain on x that is ergodic and stationary with respect to π. This means that if xⁱ˜π(x), then xⁱ⁺¹˜π(x) and therefore converges in distribution to π. The Markov chain returned by the method x⁽¹⁾, x⁽²⁾, . . . , x^{(t)}, . . . is such that x^{(t)} converges to π. This means that the chain can be considered as a sample approximately distributed from π. The Metropolis-Hastings algorithm is described as Algorithm 1 below.

Algorithm 1 Metropolis-Hastings algorithm.

| | |
|---|---|
| 1: | Initialize x⁽⁰⁾ ~ q(x) |
| 2: | for iteration i = 1,2, . . . do |
| 3: | Propose a candidate x^{cand} ~ q(x⁽ⁱ⁾\|x⁽ⁱ⁻¹) |
| 4: | $Acceptance probability α ( {x}^{cand} \vert {x}^{( i - 1 )} ) = min \{ 1 , \frac{q ( {x}^{( i - 1 )} \vert {x}^{cand} ) π ( {x}^{cand} )}{q ( {x}^{cand} \vert {x}^{( i - 1 )} ) π ( {x}^{( i - 1 )} )} \}$ |
| 5: | u ~ Uniform(u, 0.1) |
| 6: | if u < α then |
| 7: | Accept the proposal: x⁽ⁱ⁾ ← x^{cand} |
| 8: | else |
| 9: | Reject the proposal: x⁽ⁱ⁾ ← x⁽ⁱ⁻¹⁾ |
| 10: | end if |
| 11: | end for |
| 12: | return x |

The first step is to initialize the sample value for each random variable in x (this value is often sampled from the variable's prior distribution). The main loop of Algorithm 1 above is composed of three components: (1) generate a candidate sample from the proposal distribution q(x⁽ⁱ⁾|x⁽ⁱ⁻¹⁾); (2) compute the acceptance probability via the acceptance function α(x^{cand}|x⁽ⁱ⁻¹⁾) based on the proposal distributions and the target density π; (3) accept the candidate sample with probability α or reject it with probability 1−α.

The application of Algorithm 1 above to the urban trip generation is as follows. The algorithm first initializes all variables (ODT trips) xⱼ which compose the state space x, where x=(x₁, x₂, . . . , xⱼ . . . ), and it samples from their prior distribution q(xⱼ), which may include trip planner recommendations or samples from the available history. In the main loop, the algorithm samples a candidate x^{cand} from the proposal distribution q(.) of variables (ODT triples) xⱼ. For those xⱼ, which are sufficiently represented in the history, the proposal distributions q(xⱼ) can be estimated from the history. Note that each q(xⱼ) includes different realizations of xⱼ and the corresponding probabilities. For variables xⱼ with no history, the uniform distribution over top trip recommendations is used as q(xⱼ). Then, the candidate samples are accepted probabilistically based on the acceptance probability α.

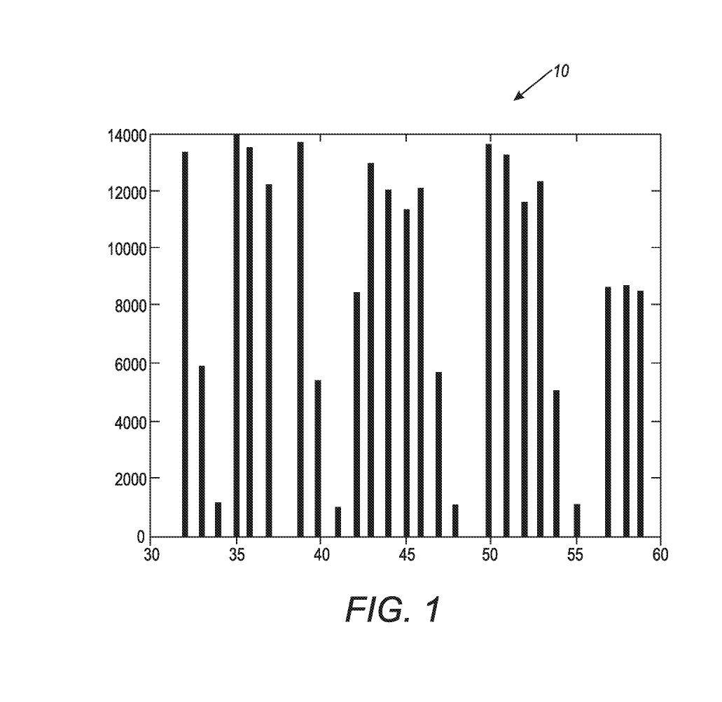

To test the aforementioned method, experiments were performed with the Metropolis-Hastings algorithm using the Nancy trip dataset (i.e., data associated with a Nancy, France trip). The dataset includes individual passenger trips, extracted from an e-card validation collection in Nancy, France. FIG. 1 illustrates a graph 10 depicting sample data from a trip dataset including the number of extracted trips by day, in accordance with an example embodiment. That is, FIG. 1 shows the number of trips per day in the collection.

For a given day d in the collection, we estimate the ODT and the target distributions as an average of the trips of the same day (e.g., Mondays) in the history prior to the day d. The target distribution π addresses the whole city set and factorizes over three terms, as follows: the trip angles distribution π₁, which characterizes the multi-goal trips; the transit time distribution π₂; and the full travel time distribution π₃. The target distribution density is given by π=π₁, π₂, π₃.

We look up in the history prior to day d and initialize all ODT trips xⱼ with their fastest realizations found in the history; this approximates well the trip plan recommendations. At each iteration, to generate candidates x^{cand}, the algorithm uniformly samples ODT triples xⱼ and uses their proposal distributions q(xⱼ) from the history when available. It computes the acceptances probability α using π and q(x).

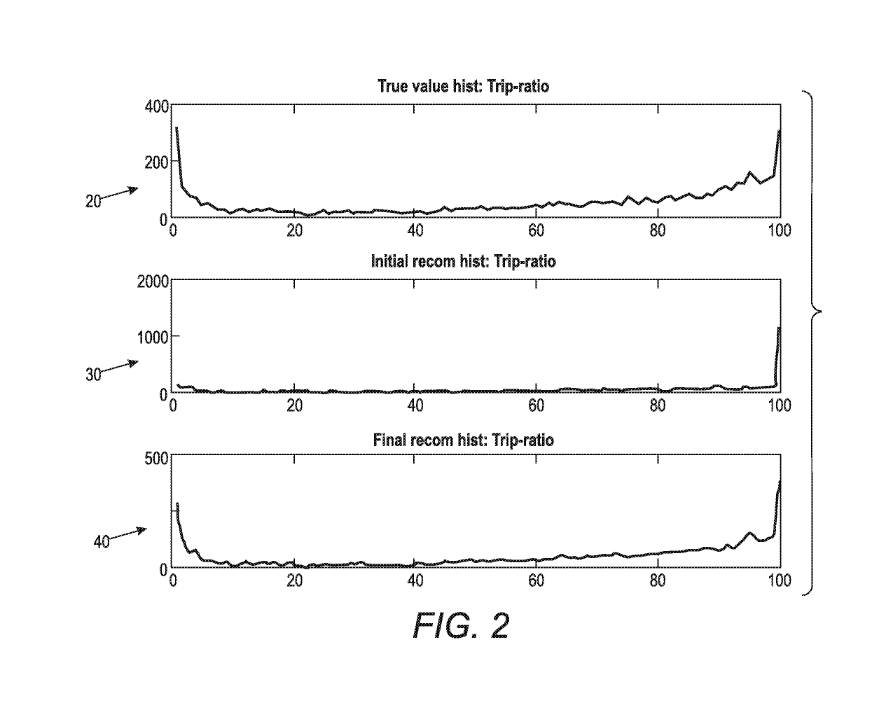

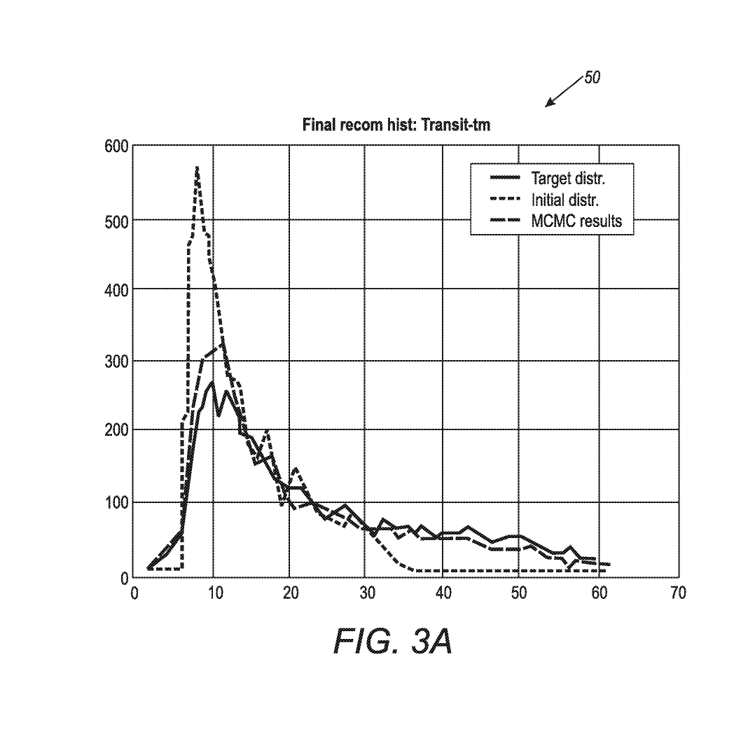

FIG. 2 illustrates three graphs 20, 30, and 40 depicting sample trip generation data including, respectively, trip angle target distribution data specifically target, initial, and final data, in accordance with an example embodiment. FIGS. 3A-3B illustrate graphs 50 and 60 depicting trip generation data with MCMC including transfer and full travel distribution data, in accordance with an example embodiment. FIGS. 2-3 show results of applying the Metropolis-Hastings algorithm for day d=54 (Saturday) in the Nancy collection. Target distributions are an average over all Saturdays prior to the day d. All variables are initiated by the fastest closest realizations over the whole history prior to the day d. FIG. 2 shows the results for the trip angle feature known for capturing the multiple goals of real trips (where the trip planner behaves poorly). FIG. 2 plots the target distribution π₁ and shows the initial angle distribution given by the fastest realization. Note the important mismatch between the target and initial goals. Graph 40 of FIG. 2 illustrates a final example distribution that can be obtained via the Metropolis-Hastings algorithm after 25K iterations. The results of the algorithm for two other target distributions, the transfer time and full travel time, are shown in FIGS. 3A-3B with respect to graphs 50 and 60.

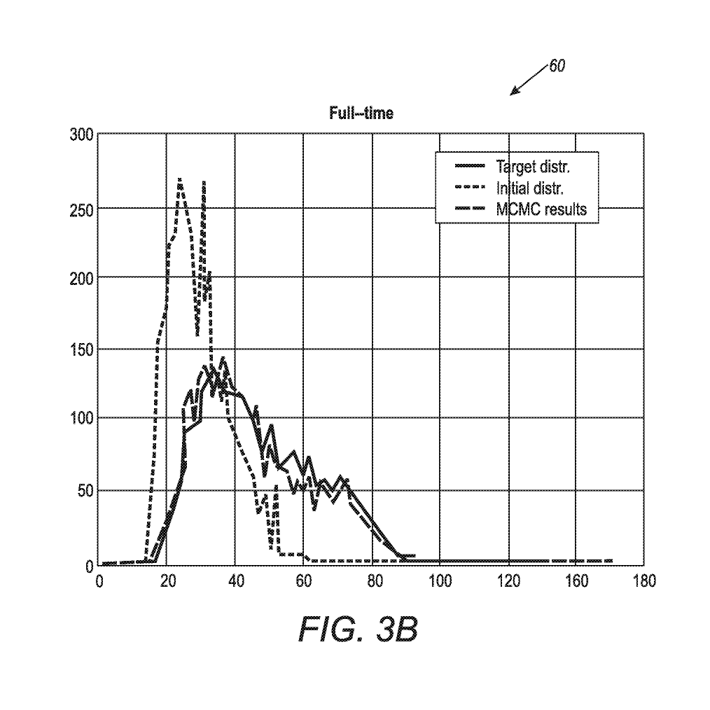

Note that the present inventors also disclose herein the MCMC convergence curb. FIG. 4 illustrates a graph 70 depicting data indicative of Metropolis-Hastings algorithm coverage, in accordance with an example embodiment. Graph 70 of FIG. 4 depicts the KL divergence between the current x^{(t)} and the target distributions π over the iterations.

The disclosed embodiments thus describe a method and system for generating a large urban trip collection, which look realistic (how usually travel in an urban zone) and can be served as an input to simulate different urban mobility scenarios. Such embodiments combine two state of art approaches based on trip planner recommendations and sampling from available trip history. The disclosed embodiments initialize all ODT triples with either historical examples or recommendations from trip planners. Such embodiments can then use the Metropolis-Hastings algorithm to generate a Markov chain of the trip collection, which converges to a desired distribution. The results of applying the MCMC algorithm to the example Nancy trip collection are also discussed herein.

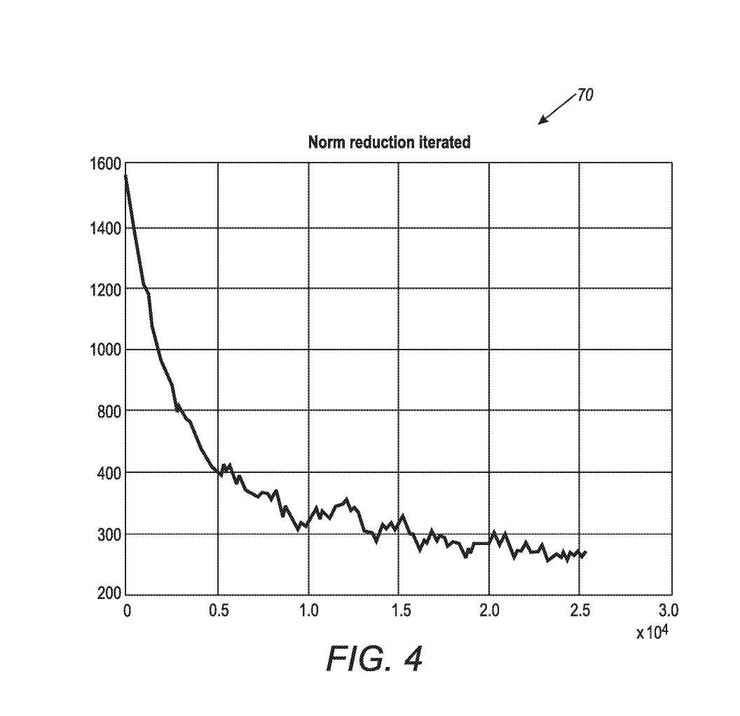

FIG. 5 illustrates a flow chart of operations depicting logical operational steps of a method 78 for generating realistic trips, in accordance with an example embodiment. The method 78 depicted in FIG. 5 can be utilized to generate realistically looking trips, using either a trip history or trip planner recommendations as a source of trip realizations. The process begins, as indicated at block 80. Then, as shown at block 84, a step or operation can be implemented for setting a set or group of constraints that the generated trip collection should satisfy to look realistic. Note that various types of constraints were previously discussed herein, such as the total trip time or/and transit time, trip angles, number of changes, trip modalities, modality sequences, and so on. Thereafter, as indicated at block 86, a step or operation can be implemented to express these constraints in the form of target probability distributions and/or densities.

Next, as shown a block 88, a step or operation can be implemented to initialize all trips in the collection by, for example, querying a trip planner or by sampling from the trip history. A test can then be performed, as indicated by decision block 90, to determine if the previously discussed Monte Carlo Markov chain application is to be applied to obtain the trips modified and look realistic and to match the collection characteristics to the target distribution. If not, then the process ends, as shown at block 94. If so (“yes”), then the result is that the modified trips are obtained and look realistic and match the collection characteristics to the target distribution (and/or the target probability densities).

As can be appreciated by one skilled in the art, embodiments can be implemented in the context of a method, data processing system, or computer program product. Accordingly, embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object-oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the users computer, partly on the user's computer, as a stand-alone software package, partly on the user's computer and partly on a remote computer, or entirely on the remote computer. In the latter scenario, the remote computer may be connected to a user's computer through a local area network (LAN) or a wide area, network (WAN), wireless data network e.g., Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example, a special-purpose computer or a general-purpose computer, or other programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

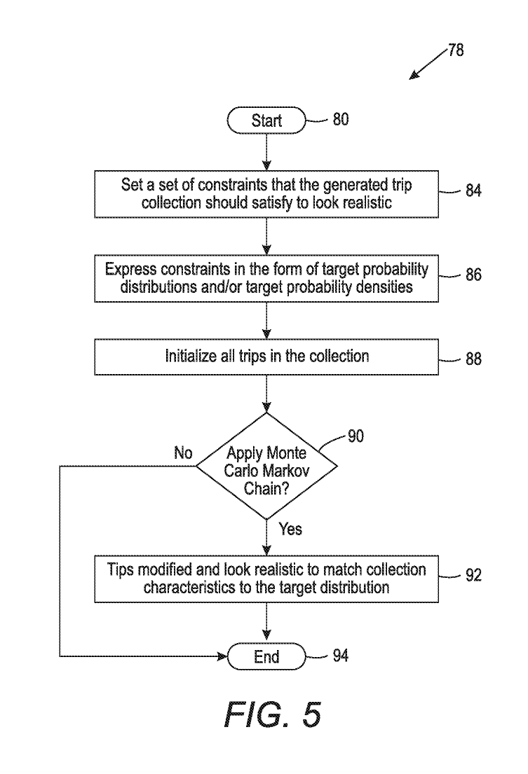

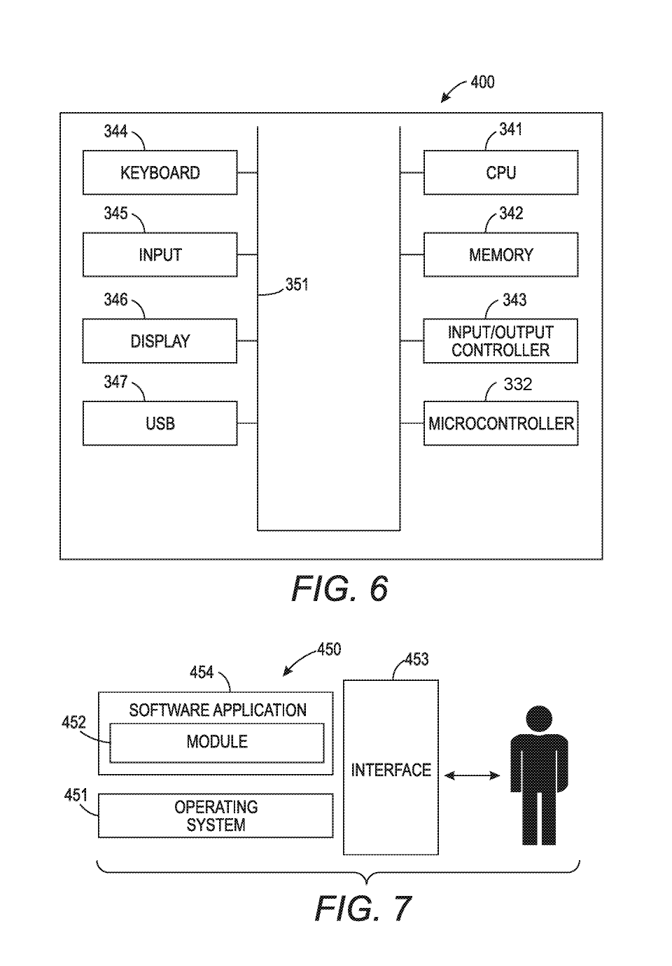

FIGS. 6-7 are shown only as exemplary diagrams of data-processing environments in which example embodiments may be implemented. It should be appreciated that FIGS. 6-7 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 6, some embodiments may be implemented in the context of a data-processing system/apparatus 400 that can include, for example, one or more processors such as a processor 341 (e.g., a CPU (Central Processing Unit) and/or other microprocessors), a memory 342, an input/Output controller 343, a microcontroller 332, a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.) and/or other peripheral connections and components.

As illustrated, the various components of data-processing system/apparatus 400 can communicate electronically through a system bus 351 or similar architecture. The system bus 351 may be, for example, a subsystem that transfers data between, for example, computer components within data-processing system/apparatus 400 or to and from other data-processing devices, components, computers, etc. The data-processing system/apparatus 400 may be implemented in some embodiments as, for example, a server in a client-server based network (e.g., the Internet) or in the context of a client and a server (i.e., where aspects are practiced on the client and the server).

In some example embodiments, data-processing system/apparatus 400 may be, for example, a standalone desktop computer, a laptop computer, a Smartphone, a pad computing device, and so on, wherein each such device is operably connected to and/or in communication with a client-server based network or other types of networks (e.g., cellular networks, Wi-Fi, etc.).

FIG. 7 illustrates a computer software system/apparatus 450 for directing the operation of the data-processing system/apparatus 400 depicted in FIG. 6. Software application 454 stored, for example, in memory 342, generally includes a kernel or operating system 451 and a shell or interface 453. One or more application programs, such as software application 454, may be “loaded” (i.e., transferred from, for example, mass storage or another memory location into the memory 342) for execution by the data-processing system/apparatus 400. The data-processing system/apparatus 400 can receive user commands and data through the interface 453; these inputs may then be acted upon by the data-processing system/apparatus 400 in accordance with instructions from operating system 451 and/or software application 454. The interface 453 in some embodiments can serve to display results, whereupon a user may supply additional inputs or terminate a session. The software application 454 can include module(s) 452, which can, for example, implement instructions or operations such as those discussed herein with respect to FIGS. 1-5 herein. Module 452 may also be composed of a group of modules or sub-modules.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 6-7 are thus intended as examples and not as architectural limitations of disclosed embodiments. Additionally, such embodiments are not limited to any particular application or computing or, data processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

The claims, description, and drawings of this application may describe one or more of the instant technologies in operational/functional language, for example, as a set of operations to be performed by a computer. Such operational/functional description in most instances can be specifically configured hardware (e.g., because a general purpose computer in effect becomes a special-purpose computer once it is programmed to perform particular functions pursuant to instructions from program software). Note that the data-processing system/apparatus 400 discussed herein may be implemented as special-purpose computer in some example embodiments. In some example embodiments, the data-processing system/apparatus 400 can be programmed to perform the aforementioned particular instructions (e.g., such as the various steps and operations described herein with respect to FIGS. 1-5 thereby becoming in effect a special-purpose computer). In other example embodiments, the data-processing system/apparatus 400 may be a general-purpose computer.

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one skilled in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, java, visual basic, etc.), or tools in the form of Very high speed Hardware Description Language (“VHDL,” which is a language that uses text to describe logic circuits)—are generators of static or sequenced specifications of various hardware configurations. The broad term “software sometimes obscures this fact” but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an example embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities may also cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each, type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a micro architecture that will carry out the instructions defined by that microprocessors defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state may be used to construct a machine based on the above technical description. Charles Babbage, for example, constructed the first computer out of wood and powered by cranking a handle.

Thus, far from being understood as an abstract idea, it can be recognized that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendors piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such and should not be disparagingly characterized as abstract ideas merely because the specifications they represent are presented in a manner that one skilled in the art can readily understand and apply in a manner independent of a specific vendors hardware implementation.

At least a portion of the devices or processes described herein can be integrated into an information processing system/apparatus. An information processing system/apparatus generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc., in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and/or firmware would be well within the skill of one skilled in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for generating realistic samples of public transportation usage to improve the operability of a public transportation system, comprising:
expressing constraints as a plurality of origin-destination-time triples;
assigning a trip to each triple among said plurality of origin-destination-time triples while ignoring capacity constraints among said constraints expressed as said plurality of origin-destination-time triples; and
utilizing a Metropolis-Hasting class sampling technique with respect to said trip, beginning with said plurality of origin-destination-time triples, to generate a realistic sample of public transportation usage based on said constraints in a form of target probability distributions and/or target probability densities and thereby improve said public transportation system by taking into account said generated realistic sample of public transportation usage.

2. The method of claim 1 wherein said constraints expressed as said plurality of origin-destination-time triples comprise: a total trip time and/or a transit time.

3. The method of claim 1 wherein said constraints expressed as said plurality of origin-destination-time triples comprise: trip angles used for detecting multi-goal trips.

4. The method of claim 1 wherein said constraints expressed as said plurality of origin-destination-time triples comprise: a number of changes.

5. The method of claim 1 wherein said constraints expressed as said plurality of origin-destination-time triples comprise: trip modalities.

6. The method of claim 1 wherein said constraints expressed as said plurality of origin-destination-time triples comprise: modality sequences.

7. The method of claim 1 wherein said constraints expressed as said plurality of origin-destination-time triples comprise at least one of: trip modalities or modality sequences.

8. The method of claim 1 further comprising generating a Markov chain of said trip utilizing said Metropolis-Hasting class sampling technique, wherein said Markov chain converges to a desired distribution comprising at least one of said target probability distributions and/or said target probability densities.

9. An apparatus for generating realistic samples of public transportation usage to improve the operability of a public transportation system, said apparatus comprising:
at least one processor; and
a non-transitory computer-usable medium embodying computer program code, said computer-usable medium capable of communicating with said at least one processor, said computer program code comprising instructions executable by said at least one processor and configured for:
expressing constraints as a plurality of origin-destination-time triples;
assigning a trip to each triple among said plurality of origin-destination-time triples while ignoring capacity constraints among said constraints expressed as said plurality of origin-destination-time triples; and
utilizing a Metropolis-Hasting class sampling technique with respect to said trip, beginning with said plurality of origin-destination-time triples, to generate a realistic sample of public transportation usage based on said constraints in a form of target probability distributions and/or target probability densities and thereby improve said public transportation system by taking into account said generated realistic sample of public transportation usage.

10. The apparatus of claim 9 wherein said constraints expressed as said plurality of origin-destination-time triples comprise: a total trip time and/or a transit time.

11. The apparatus of claim 9 wherein said constraints expressed as said plurality of origin-destination-time triples comprise: trip angles used for detecting multi-goal trips.

12. The apparatus of claim 9 wherein, said constraints expressed as said plurality of origin-destination-time triples comprise: a number of changes.

13. The apparatus of claim 9 wherein said constraints expressed as said plurality of origin-destination-time triples comprise: trip modalities.

14. The apparatus of claim 9 wherein said constraints expressed as said plurality of origin-destination-time triples comprise: modality sequences.

15. The apparatus of claim 9 wherein said constraints expressed as said plurality of origin-destination-time triples comprise at least one of: trip modalities or modality sequences.

16. The apparatus of claim 9 wherein said instructions are further configured for generating a Markov chain of said trip utilizing said Metropolis-Hasting class sampling technique, wherein said Markov chain converges to a desired distribution comprising at least one of said target probability distributions and/or said target probability densities.

17. A non-transitory processor-readable medium storing computer code representing instructions to cause a process for generating realistic samples of public transportation usage to improve the operability of a public transportation system, said computer code including code to:
express constraints as a plurality of origin-destination-time triples;
assign a trip to each triple among said plurality of origin-destination-time triples while ignoring capacity constraints among said constraints expressed as said plurality of origin-destination-time triples; and
utilize a Metropolis-Hasting class sampling technique with respect to said trip, beginning with said plurality of origin-destination-time triples, to generate a realistic sample of public transportation usage based on said constraints in a form of target probability distributions and/or target probability densities and thereby improve said public transportation system by taking into account said generated realistic sample of public transportation usage.

18. The non-transitory processor-readable medium of claim 17 wherein said constraints expressed as said plurality of origin-destination-time triples comprise: a total trip time and/or a transit time.

19. The non-transitory processor-readable medium of claim 17 wherein said constraints expressed as said plurality of origin-destination-time triples comprise: trip angles used for detecting multi-goal trips.

20. The non-transitory processor-readable medium of claim 17 wherein said constraints expressed as said plurality of origin-destination-time triples comprise: a number of changes and/or trip modalities and/or modality sequences.
